(19) United States
(12) Patent Application Publication
(10) Pub. No.: US 2007/0210492 A1
(43) Pub. Date: Sep. 13, 2007

(54) Retortable blow-molded container and process

(76) Inventors: Kirk E. Maki, Tecumseh, MI (US); John Daly, Millersville, MD (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/371,239

(22) Filed: Mar. 9, 2006

(51) Int. Cl. B29C 49/00

(52) U.S. Cl. 264/523; 264/528

(57) ABSTRACT

Hot fill and retort stable containers can be made by blowmolding parisons made with polyalkylene terephthalate and a sufficient amount of nucleating agent under conditions that include heated molds, directional cooling air on container stress areas from vents formed into a push rod that is extended into the molded container while still in the heated mold, and an adequate residence time to grow the desired degree of crystallinity.

### FIELD OF INVENTION

This invention relates to improved blow molded containers wherein the containers are made of a material comprising polyethylene terephthalate and a sufficient amount of nucleating agent to form a blow molded bottle with low deformation when filled with a hot liquid. Preferably, the mixture has a viscosity sufficiently low for shaping under blow molding and heatsetting conditions sufficient to form a unitary bottle having low deformation under hot fill conditions. Even more preferably, the bottle also exhibits collapse and deformation panels that will accommodate vacuum pressures formed within the container when the contents cool.

### BACKGROUND OF THE INVENTION

Polyester containers, particularly those made from polyethylene terephthalate, known by its acronym “PET”, are well-suited for packaging of a variety of liquids. PET is a semicrystalline polymer with a melting point (Tm) in the range 250° C. to 265° C. and a glass transition temperature (Tg) in the range 70° C. to 80° C. PET is said to be available in viscosities that range from about 0.7 to about 1.1 dl/g. (See, U.S. Pat. No. 5,322,663 in column 2.) The modern “wisdom”, however, is that PET having an intrinsic viscosity of greater than about 0.90 is thought to be useful only for thermoforming of generally flat articles, and PET with an intrinsic viscosity of about 0.84 down to about 0.74 is only useful for blowmolding of clear, hollow containers.

The process of blow molding hollow containers is as much of an art as it is a science. In a conventional blow molding process, pellets of PET are passed through a melt extruder and formed into a preform which can be molded later (2 step process) or passed directly into the mold (1 step process). See generally, U.S. Pat. No. 6,497,569. The preform is amorphous PET has an open threaded neck (by which the unit is held and moved throughout the process by the associated handling devices) and an amorphous mass integrally connected thereto. The walls and bottom of the molded bottle will be formed from this amorphous mass when heated to softening within the mold, extended downwardly with a stretching rod, and expanded both longitudinally and radially by air injected thru openings in the stretching rod at a pressure, angle, and distribution sufficient to PET in the desired distribution around the container perimeter. When cooled, the amorphous PET container is clear, flexible, and has a desirable balance of gas permeation characteristics that make it well suited as a light weight, resealable container for a wide variety of liquids. Because PET has little or no discernible shrinkage, the molded container is the same as the mold surface which simplifies the mold design and provides consistently high quality containers.

In thermoforming, PET is formed into flat sheets, softened, and pulled against a mold surface. Such a sequence places less demands for flow on the material, so the intrinsic viscosity of the molded PET material can be correspondingly higher. See, U.S. Pat. No. 4,463,121. The need for clarity of the molded part is also much less or undesirable, so greater crystallinity can be used for greater resistance to heat without softening.

Crystallinity in PET is found when the terminal ends of the polymer contract and curl to form hard spherulites. These spherulites make the material stiffer (increased intrinsic viscosity), reduce clarity, and provide resistance against softening and deformation at higher temperatures. Thus, high crystallinity has been desirable for thermoformed trays and similar thermoformed products.

The loss of clarity that follows increased PET crystallinity has not been desired, however, for the traditional uses of PET containers. The use of any crystallizing procedures for enhanced strength tends to be limited to areas where labels with be placed or the base where the overall useful clarity of the container is not compromised. Such restrictions have posed limitations on the types of liquids that can be filled into the molded bottles and the processes used to fill them. Specifically, the relatively low softening temperature of blow molded bottles from PET with an IV of about 0.82-0.84 is about 99° C. (210° F.) which precludes the use of a retort for sterilization of the filled product and would require the expensive fill system machinery and product limitations of an aseptic fill process.

It would be desirable to have a blow molded PET container with sufficient heat resistance to withstand retort conditions including a temperature of about 127° C. (260° F.) without deformation or loss of container integrity. Unfortunately, the use of PET materials with high intrinsic viscosity are too stiff to form with commercial blow molding equipment and operating conditions so conventional thermoforming materials and operations are not effective.

The art has tried many methods to control the crystallinity of molded PET containers. Examples include the melt blending of inorganic nucleating agents and crystallization accelerators to the PET with subsequent forming. See, U.S. Pat. No. 4,417,021 the disclosure of which is hereby incorporated by reference. Other techniques include varied thickness of molten material within the mold (thicker material slows the cooling and increases crystallinity), external heating of mold sections where additional crystallinity is desired, and polymeric blends that are said to exhibit additional strength.

It would be desirable to have a method for increasing the crystallinity of blow molded PET and similar polyalkylene terephthalate containers under blow molding conditions sufficient to provide sufficient crystallinity to allow the molded container to be filled with liquids at temperatures as high as 127° C. without softening or deformation. Even more preferable would be a method for blow molding standard grade PET having a commercially available initial intrinsic viscosity into a retort stable container as a replacement for conventional tin or aluminum cans.

### SUMMARY OF THE INVENTION

It is an object of the invention to provide a process for blow molding hollow containers that can be filled with liquids at a temperature of about 127° C. or higher without detrimental container deformation or loss of container integrity.

It is another object of the invention to provide a process for making PET containers that can withstand retort conditions without deformation or loss of container integrity.

In accordance with these and other objects of the invention that will become apparent from the description herein, a process according to the invention comprises (a) mixing (i) a nucleation agent and (ii) polyalkylene terephthalate having an intrinsic viscosity of less than 0.85 dl/g in a melt extruder under melt extrusion conditions sufficient to form a moldable plastic mass; (b) forming a parison from said plastic mass; (c) molding said parison into a hollow container in a shaped and heated mold for a time sufficient to form a hollow container that can be filled with a heated liquid at a temperature of 127° C. without detrimental deformation or loss of container integrity.

Containers made according to the present invention are heat stable and resistant to deformation. These containers can be used for filling hot foods (liquids and/or solids) and can withstand the elevated temperatures of retort sterilization for the packaging and distribution of foods sealed under aseptic conditions that could only be distributed previously in glass or metal containers.

### DETAILED DESCRIPTION OF THE INVENTION

The invention relates to a unitary, molded bottle made from blow-molding a moldable preform comprising polyalkylene terephthalate, such as polyethylene terephthalate (“PET”) and polybutylene terephthalate (“PBT”), and a nucleating agent in a quantity sufficient to create and grow crystal density within the molded polyalkylene terephthalate under elevated temperature. The method involves mixing polyalkylene terephthalate with finely divided nucleating agent at the feed end of a melt extruder so that the ejected mass represents a homogeneous mixture of polyalkylene terephthalate and nucleating agent. When formed into a hollow container in a heated mold, the nucleating agent encourages the development of crystallinity that enhances structural integrity and resistance to deformation when exposed to elevated temperatures. In a preferred embodiment, selective cooling of first areas of the newly-formed container while in a heated mold permits the development of enhanced crystallinity in the uncooled second areas without use of a post-molding process or conditioning step.

It will be understood that the following definitions are applicable to the present invention.

Intrinsic Viscosity (IV): Intrinsic viscosity of the polymer samples was measured by the Goodyear Method R-103B. The polymer solvent was prepared by mixing one volume of trifluoroacetic acid and 1 volume of dichloromethane. 0.10 g of polymer were added to a clean dry vial and 10 mL of the prepared solvent mixture was added using a volumetric pipette. The vial was sealed and shaken for 2 hrs or until the polymer dissolved. The solution so prepared was forced through a flow through capillary rheometer, Viscotek Y900. The temperature for the viscosity measurement was fixed at 19° C.

Density: The density of the films was measured at 23° C. in a density gradient column, made from a solvent mixture of carbon tetrachloride and heptane.

The polyalkylene terephthalates of this invention are thermoplastic polyester resins which include the reaction products of terephthalic acid, as well as derivatives thereof, and aliphatic or cycloaliphatic C₂-C₁₀ diols. Such reaction products include polyalkylene terephthalate resins, including polyethylene terephthalate, polybutylene terephthalate, polytetramethylene terephthalate, and copolymers and mixtures thereof. As is known to the art, these polyester resins may be obtained through the polycondensation reaction of terephthalic acid, or a lower alkyl ester thereof, and an alkylene diol. By way of example, as is known, polyethylene terephthalate or polybutylene terephthalate may be produced by polycondensation of dimethyl terephthalate and ethylene glycol or 1,4-butane diol, respectively, after an ester interchange reaction. PET usually used for blow molding of hollow containers generally exhibits an intrinsic viscosity within the range from about 0.6 to about 2 dl/g.

Preferred polyalkylene terephthalates include at least 75 mol %, preferably not less than 80 mol %, of terephthalic acid groups as based on the dicarboxylic acid component. Preferred polyalkylene terephthalates include at least 75 mol %, preferably not less than 80 mol %, of the aliphatic C₂-C₁₀ or cycloaliphatic C₆-C₂₁ diol component. Of these, preferred polyalkylene terephthalates are polyethylene terephthalate (PET) and polybutylene terephthalate (PBT) with PET being the most preferred.

The preferred polyalkylene terephthalates may contain up to about 25 mol % of groups of other aliphatic dicarboxylic acids having from about 4 to about 12 carbon atoms as well as aromatic or cycloaliphatic dicarboxylic acid groups having from about 8 to about 14 carbon atoms inclusive. Non-limiting examples of these monomers include the following: isophthalic acid, phthalic acid, succinic acid, adipic acid, sebacic acid, azelaic acid, cyclohexane diacetic acid, naphthalene-2,6-dicarboxylic acid, 4,4-diphenylenedicarboxylic acid, as well as others not particularly denoted here. Preferred polyalkylene terephthalates may also contain up to 25 mol % of other aliphatic C₂-C₁₀ or cycloaliphatic C₆-C₂₁ diol components. By way of example and not by way of limitation, examples include: neopentyl glycol, pentane-1,5-diol, cyclohexane-1,6-diol, cyclohexane-1,4-dimethanol, 3-methyl pentane-2,4-diol, 2-methyl pentane-2,4-diol, propane-1,3-diol, 2-ethyl propane-1,2-diol, 2,2,4-trimethyl pentane-1,3-diol, 2,2,4-trimethyl pentane-1,6-diol, 2,2-diethyl propane-1,3-diol, 2-ethyl hexane-1,3-diol, hexane-2,5-diol, 1,4-di(β-hydroxy-ethoxy-)benzene, 2,2-bis-(4-hydroxypropoxy-phenyl)propane, as well as others which are not particularly denoted here.

The polyalkylene terephthalates may be either straight or branched in their configuration. They may be branched by the inclusion of small quantities of trihydric or tetrahydric alcohols, or tribasic or tetrabasic carboxylic acids. Preferred among these include: trimellitic acid, trimethylol-ethane, trimethylol-propane, trimesic acid, and pentaerythritol. In accordance with the present invention, virgin and/or reprocessed polyalkylene terephthalate and polyethylene can be utilized.

The polyalkylene terephthalate polymer can include various additives that do not adversely affect the polymer. For instance, some such additives are stabilizers, e.g., antioxidants or ultraviolet light screening agents, extrusion aids, additives designed to make the polymer more degradable or combustible, and dyes or pigments. Moreover, cross-linking or branching agents such as are disclosed in U.S. Pat. No. 4,188,357 can be included in small amounts in order to increase the melt strength of the polyalkylene terephthalate.

If desired, PET can be mixed with 0-25 wt % of polyethylene naphthalate (PEN) with techniques known in the art to reduce oxygen permeability and increase heat resistance for higher fill temperatures. For example, PET bottles can be filled at temperatures from ambient up to about 85° C. for such products as personal care compositions, wine, liquor, soft drinks, mustard, mayonnaise, peanut butter, salad dressing, and sports drinks. Blends of PET and PEN can reduce oxygen permeation by a factor of 10 and can allow the packaging of oxygen sensitive foods, such as tomato-based foods like ketchup, strawberry puree, piña colada mix, and the like.

As noted previously, PET is commercially available with an IV of at least 0.90, preferably about 1.0, for use in thermoforming operations and similar processes that employ flat sheets of PET. Such processes rely on a forming mechanism that employs softening and deformation against a mold surface. Such material is too stiff, however, to be useful for blow molding of hollow containers. Thus, the market makes available PET with an IV within the range of 0.74 (the lowest commercially available) to 0.84 for blowmolding processes. Most blowmolding operations use a PET material with an IV within the range of about 0.79 to about 0.81. The present invention uses this “blowmolding” grade PET as the feed into the extruder.

Please note that a grade of PET is available under the designation CPET or “crystallized” PET. This material is not a fully crystallized material. Rather, it is conventional PET that has been treated with heat so as to crystallize the outside surface of the pellet and provide somewhat better handling characteristics under certain conditions. Once introduced into a melt extruder, however, the crystallization in the outer surface is removed as the pellet melts and becomes homogeneously mixed with the remaining PET and other ingredients in the extruder. It is within the invention to use pellets and “crystallized” pellets of PET having an IV suitable for use in blowmolding processes. Suitable sizes for the pellets are those commercially available, e.g., about 0.0625 to 0.250 inches across.

An amount of nucleating agent is added to the polyalkylene terepbthalate at the feed end of the extruder in an amount sufficient to increase the crystallization of the resulting molten mass at the exit of the extruder. Such an increase in crystallinity is reflected by a loss of clarity in the extruded mass relative to the molten material without the nucleating agent. Additional crystallinity is formed in the molded container during the blowmolding process to produce a hollow container that is translucent to opaque in appearance over at least a portion of the overall height of the container and preferably throughout the entire length of the container, including the bottom, body, shoulder, and threaded neck portions thereof. Typical amounts of nucleating agent found to be sufficient are within the range from about 0.5 to about 8 wt % (based on the weight of the polyalkylene terephthalate) and preferably within the range of about 2-4 wt %.

The nucleating agent can comprise any polymeric or inorganic component effective to induce polyalkylene crystallization at elevated temperatures. Preferred nucleating agents include finely divided polyolefin solids. Polyethylenes denote a group of ethylene-based polyolefin polymers. Although polyethylenes can be linear or branched, most widely used polyethylenes are linear polyethylenes. Linear polyethylenes are classified by density, and they include low-density polyethylene (LDPE), linear low density polyethylene (LLDPE), medium-density polyethylene (MDPE), high-density polyethylene (HDPE), and the like. Preferred polyethylene resins include homopolymers such as low, medium and high density polyethylenes; copolymers having a major proportion of ethylene, generally at least about 60 weight %, preferably at least about 70 weight %, and other alpha-olefins containing 3-10 or more carbon atoms; and mixtures thereof. Illustrative but not limiting examples of such other alpha-olefins are propylene, butene-1, pentene-1,3-methylbutene-1, hexene-1,4-methylpentene-1,3-ethylbutene-1, heptene-1, octene-1, decene-1,4,4-dimethylpentene-1,4,4-diethylhexene-1,3,4-dimethylhexene-1,4-butyl-1-octene, 5-ethyl-1-decene, 3,3-dimethylbutene-1, and the like. Of these, the most preferred polyethylene nucleating agent is linear low density polyethylene.

While the precise nature and action mode of the nucleating agents is not well understood, it is believed that the presence of the nucleating agent assists in or encourages the formation of the polyalkylene terephthalate spherulites known as “crystallization” which permits the final container to resist higher temperatures without detrimental deformation or softening. Unexpectedly, it has also been found that certain nucleating agents, such as the low density polyalkylenes, seem to act as mold release agents that facilitate the removal of the molded container.

Additional protection against various wavelengths of light can be introduced into the container material by way of UV absorbers, dyes, and similar light absorbing or reflecting materials.

In the present invention, blowmolding is conducted on conventional blow molding machines of the type that are usually used for the blow molding of hollow containers from thermoplastic resins, such as PET. More specifically, a hollow container is produced by mixing and melting the polyalkylene terephthalate and nucleating agent until homogeneous and molten. A melt extruder of single or double screw construction, and extruding the plasticized composition through an annular die having threads about a neck portion to form a threaded parison as an intermediate component. Once formed, the threaded neck portion of the parison is used to move and transport the parison through its subsequent steps. Threaded parisons may be recovered and stored in suitable storage facilities for later use in making hollow containers in what is known as a “two step” blowmolding process. Alternatively, the as-formed parison may be used immediately after formation and while relatively pliable for the immediate manufacture of blowmolded hollow containers (the “one step” process). Regardless, the threaded parison should be rendered pliable before molding by exposing the parison to heat at suitable locations along its length.

The pliable parison is positioned and extended into a heated mold with air from a blow nozzle that is annular to a push rod, typically a hollow rod, that is extended progressively into the container. The blow nozzle air and extension by the push rod inflates the container and forces the parison material outwardly until it conforms to the inside walls of the mold cavity. Continuing air pressure through the blow nozzle holds the molded parison against the heated walls of the mold.

Preferably, the mold is heated to a temperature sufficient to encourage crystal growth within the nucleated PET material. If desired, the entire container may be subjected uniformly to the heated mold for the development of crystal growth throughout the container walls, bottom, shoulder, and neck areas. Preferably, however, only selected portions of the container are allowed to develop crystallinity. Areas where heightened crystallinity is desired include the bottom and upper shoulder areas.

In the present invention, crystallinity is developed in these target areas by passing relatively high pressure cooling air (about 10-40 psig higher than air introduced through the blow nozzle) through directionally oriented vents in the push rod. This cooling air is passed intermittently or, preferably, continuously through the vents and over first areas of the molded container where enhanced crystallinity is not desired, e.g., the neck and bottom corner areas, while allowing crystal growth in second areas of the container that are not in direct cooling contact with air from the directional vents. Cooling air is passed at a rate related to the temperature of the feed air and at a sufficient volumetric rate to reduce the temperature of the contacted first areas of the container to a temperature below that relative to the areas where enhanced crystallinity is desired. Such an “inside” cooling method provides good control and reproducibility in the manufacturing process.

The directional cooling air from the push rod vents are preferably directed against stressed areas of the molded bottle that are highly stretched and subject to deformation. The directional cooling air prevents shrinking and deformation in these stressed areas. Directional push rod vents are shaped and directed to address stress areas for each container design because each container design will subject the molded container to stresses in different areas.

Desirably, the mold is heated with a circulating fluid, resistance heat, infrared, or other means to prevent cooling and to encourage the growth of crystallites within the nucleated polyalkylene terephthalate. Preferably, the actual molding process is performed at a temperature within the range of about 220°-303° F. (104-151° C.) for a time within the range from about 5-10 seconds, more preferably within the range of 6-8 seconds, to allow sufficient time for the growth of adequate crystallinity to form a hollow, blowmolded container that is capable of being filled with liquids at a temperature of greater than 210° F. (99° C.) without detrimental deformation or softening. Indeed, tests have shown that blowmolding 0.8 IV PET and 2-4 wt % LLDPE within the above conditions can form substantially opaque containers that can be subjected to retort sterilization temperatures of about 260° F. (127° C.) and higher without deformation. Such containers represent acceptable, resealable, non-denting, lighter replacements for metal cans for various nutritional foods and beverages that require sterile packaging conditions for distribution and storage.

The gas to be blown into the parison may be air, nitrogen or any other nonreactive gas. From an economic viewpoint, air is usually used under a blowing pressure of preferably 3 to 10 kg/cm². Furthermore, special blow-molding machines such as a three-dimensional molding machine, may also be used. It is also possible to form a multilayered molding by forming one or more layers of the composition of the present invention and combining them (e.g. via coextrusion) with layers made from other materials.

The stretch ratios exerted on the parison in the blowmolding process that can be used for the invention are those within the range of greater than about 2, generally 2.25-2.75, for axial elongation and greater than about 5, generally 5.5-10, for hoop elongation relative to the outside dimensions of the unstretched parison. Heat setting processes after formation may be used to reduce residual stresses and induce additional crystallization, if desired.

The containers that can be made according to the invention include all of the conventional geometries (oval, square, round) in cross section as well as those that include horizontal ribs and flexure panels in the body and shoulder for controlled deformation when filled with hot liquids that will subsequently cool and exert vacuum pressures from within the container via any gases remaining therein. The bottom should be concave or otherwise shaped to provide strength and durability to the shaped container.

1. A blowmolding process comprising the steps of
(a) mixing: (i) a nucleating agent; and (ii) polyalkylene terephthalate having an intrinsic viscosity of less than 0.8 dl/g in a melt extruder under melt extrusion conditions sufficient to form a moldable plastic mass;
(b) forming a parison from said plastic mass;
(c) molding said parison into a hollow container in a heated mold for a time sufficient to form a hollow container that can be filled with a heated liquid at a temperature of at least 212° F. (99° C.) without detrimental deformation or loss of container integrity.

2. A process according to claim 1 wherein said nucleating agent comprises finely divided polyolefin solids.

3. A process according to claim 2 wherein said polyolefin solids include a linear polyethylene.

4. A process according to claim 3 wherein said nucleating agent comprises linear low density polyethylene solids.

5. A process according to claim 1 wherein said polyalkylene terephthalate include at least 75 mol % of terephthalic acid groups as based on the dicarboxylic acid component.

6. A process according to claim 5 wherein said polyalkylene terephthalate includes at least 75 mol % of an aliphatic C₂-C₁₀ or cycloaliphatic C₆-C₂₁ diol component.

7. A process according to claim 5 wherein said polyalkylene terephthalate is a polyethylene terephthalate or polybutylene terephthalate.

8. A process according to claim 1 wherein the molding is performed at a temperature within the range of about 220°-303° F. (104-151° C.) for a time sufficient for the growth of crystallinity to form a hollow, blowmolded container that is capable of being filled with liquids at a temperature of greater than 210° F. (99° C.) without detrimental deformation or softening.

9. A process according to claim 1 wherein said parison comprises 2-4 wt % linear low density polyethylene nucleating agent.

10. A process according to claim 1 wherein said container is substantially opaque and can be subjected to retort sterilization temperatures of about 260° F. (127° C.) without deformation.

11. A process according to claim 1 wherein the molding step comprises expanding said parison against said mold with air at a first pressure through a blow nozzle and cooling stress areas of said container with cooling air at a second pressure through directional vents in a push rod that has been extended into said parison.

12. A process according to claim 11 wherein the molding step further comprises cooling first areas of the container within said mold by directing said cooling air over said first areas while allowing crystal growth in second areas of the container.

13. A hollow, blowmolded container made according to the process of claim 1.

14. A hollow, blowmolded container made according to the process of claim 10.
